(19) United States
(12) Patent Application Publication
(10) Pub. No.: US 2026/0020521 A1
(43) Pub. Date: Jan. 22, 2026

(54) Feederhouse of a Combine Harvester

(71) Applicant: AGCO do Brasil Soluções Agrícolas Ltda., Jundiaí (BR)

(72) Inventor: Marcelo Carpenedo, Sapucaia do Sul (BR)

(21) Appl. No.: 19/264,651

(22) Filed: Jul. 9, 2025

(30) Foreign Application Priority Data
Jul. 19, 2024 (GB) 2410644.5

(51) Int. Cl. A01D 41/12; A01D 61/00

(52) U.S. Cl. CPC A01D 41/1252; A01D 61/008

(57) ABSTRACT

A feederhouse of a combine harvester has a dust ejection system for sucking dust from within an outer housing of the feederhouse, in particular from a flow in the opposite direction to the main material flow. An opening in an outer wall communicates with an outlet of the dust ejection system. An upstream end of the opening is connected to a convex guide surface which extends in the downstream direction and curves towards the outlet. This improves the efficiency of the ejection system.

### CROSS REFERENCE TO RELATED APPLICATIONS

This application claims the benefit of the filing date of U. K. Patent Application 2410644.5, “Feederhouse of a Combine Harvester,” filed Jul. 19, 2024, the entire disclosure of which is incorporated herein by reference.

### FIELD

Embodiments of the present disclosure relate generally to combine harvesters, and in particular to the feederhouse used to deliver crop material to the threshing system of the combine harvester.

### BACKGROUND

A combine harvester typically includes a crop cutting head (the header) and a threshing system for detaching grains of cereal from the ears of cereal. A delivery system delivers the cut crop to the threshing system, known as the feederhouse. A separating apparatus is downstream of the threshing system, and a grain cleaning apparatus receives grain from the separating apparatus. A stratification pan aims to stratify the material into a layered structure of grain at the bottom and light chaff and other material other than grain (MOG) at the top. Together, the threshing, separating and cleaning system are known as the processor.

The feederhouse is typically in the form of a conveyor chain or belt with cross bars that transport the crop material.

There are various designs for the threshing system and for the separating apparatus (e.g. axial or transverse) as well as for the grain cleaning apparatus. However, in all designs, there is a flow of material from the threshing system to the separating apparatus, and between the separating apparatus and the grain cleaning unit.

During harvesting of very dry crops one of the natural inconveniences is the high amount of dust around the combine, especially over the header and feederhouse, which can cause an obstruction to the visibility of the operator. The feederhouse system has an additional issue arising from so-called back feeding, which is the flow of air and dust coming back from the processor to the feederhouse. This back feeding, which is commonly highly dense in dust, also decreases the operator visibility.

One known way to minimize these effects is to install dust ejectors to provide dust removal before the dust is released from the feederhouse in the header direction.

Current ejector systems typically include a fan, a drive system and a channel installed generally over the feederhouse, acting as a suctioning system. There are known implementations, but they all use the basic principle of directly sucking excess dust in order to avoid it being released to the front of the combine.

The suctioning efficiency is one of the main issues for this system, due to the need for additional power from the combine to increase the suction if there is inefficient suction performance. Current solutions result in turbulent air flows as a result of the limitations resulting from the manufacturing processes used for the various parts (such as sheet metal plates and bending and welding functions). In known designs, the suction area is basically flat, leading to opening created by laser cutting a sheet metal plate of the outer housing of the feederhouse.

There is a need for more efficient air flow processing of the dust ejection system.

### BRIEF SUMMARY

The concept of this disclosure is defined by the claims. According to examples in accordance with this disclosure, there is provided a feederhouse of a combine harvester, comprising:
an outer housing;
front and rear sprockets inside the outer housing;
a belt inside the outer housing extending around the sprockets; and
a dust ejection system comprising a fan for sucking dust from within the outer housing and an outlet for delivering the sucked dust,
wherein the outer housing comprises an outer wall having an opening which communicates with the outlet, wherein the outer wall is at a side of the belt at which the belt movement direction is opposite to a main material flow direction,
and wherein an upstream end of the opening is connected to a convex guide surface, wherein the curvature extends in the downstream direction and curves towards the outlet.

The convex guide surface promotes flow from within the outer housing to the outlet. In particular, it promotes the Coanda effect, by which a fluid jet has a tendency to stay attached to a convex surface, thereby entraining fluid from surrounding areas to create a region of lower pressure. This lower pressure assists in transferring material from within the outer housing to the outlet, and thereby enables efficiency improvements for the dust ejection system, in particular the fan.

The convex guide surface for example extends across a width of the opening, with a constant cross sectional shape along the width direction. This cross sectional shape is the convex curve, and it lies in a plane parallel with the flow direction.

The convex guide surface for example comprises the material, or a portion of the material, which has been removed from the outer wall to create the opening. For example, the opening can be formed by laser cutting (on three sides) and pressing to form the convex shape.

In one example, a lower side of the belt has belt movement in the main material flow direction and an upper side of the belt has belt movement opposite to the main material flow direction. Thus, the main material flow is underneath the belt, and the back feeding flow is over the belt.

The outer housing may then comprise a top wall over the upper side of the belt, and the opening (or openings) is provided in the top wall.

The top wall for example comprises a line of openings extending across a width of the outer housing. This maintains the structural integrity of the housing compared to a continuous opening. Each opening then has its own associated convex guide surface.

This disclosure also provides a combine harvester comprising:
a crop cutting head;
the feederhouse as defined above;
a threshing system;
a separating system; and
a grain cleaning system for receiving the cut and threshed crop material.

### BRIEF DESCRIPTION OF THE DRAWINGS

One or more embodiments of this disclosure will now be described, by way of example only, with reference to the accompanying drawings, in which:

FIG. 1 shows a combine harvester which may be adapted in accordance with this disclosure;

FIG. 2 shows one example of threshing system and grain cleaning apparatus in more detail;

FIG. 3 shows a feederhouse;

FIG. 4 shows the feederhouse of FIG. 3 from beneath with components removed to show the opening design;

FIG. 5 shows the feederhouse of FIG. 3 in side view and is used to explain the flows within the feederhouse;

FIG. 6 shows the shape of the guide surface more clearly in side view; and

FIG. 7 shows the guide surface more clearly in perspective view.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure relates to a feederhouse of a combine harvester that has a dust ejection system for sucking dust from within an outer housing of the feederhouse, in particular from a flow in the opposite direction to the main material flow. An opening in an outer wall communicates with an outlet of the dust ejection system. An upstream end of the opening is connected to a convex guide surface which extends in the downstream direction and curves towards the outlet. This improves the efficiency of the ejection system.

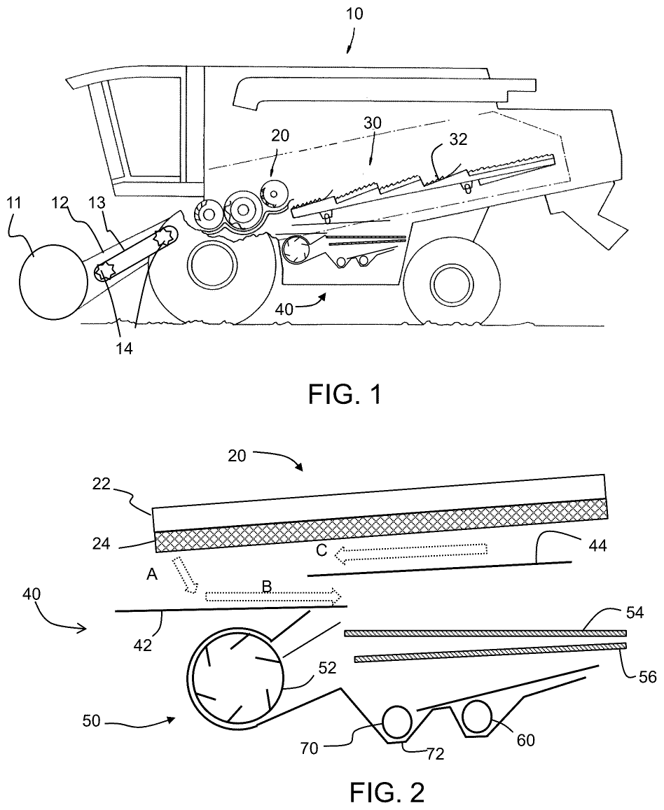

FIG. 1 shows a known combine harvester 10 to which the teachings of this disclosure may be applied. A crop cutting head 11 (known as the header) for example comprises a wide laterally extending transverse auger, which cuts the crop material and drives it inwardly towards a central area. A front elevator housing 12 receives the cut crop material and includes a feederhouse for transporting the crop material.

The feederhouse comprises a belt 13 (or a pair of spaced apart belts) driven around sprockets 14. The sprockets have drive pins which engage with gaps between teeth along the inner surface of the belt.

The feederhouse delivers the crop material to a threshing system 20 for detaching grains of cereal from the ears of cereal, and a separating apparatus 30 which is connected downstream of the threshing system 20. The threshing system comprises one or more threshing units, in particular rotors, and associated concaves.

In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

In the example shown, the threshing system 20 is a tangential-flow ‘conventional’ threshing system, i.e. formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e. formed by rotating elements with an axis of rotation in the longitudinal direction (direction of travel). For example, the threshing section may have axially-aligned rasp bars spaced around the front section whilst the separating section has separating elements or fingers arranged in a pattern, e.g. a spiral pattern, extending from the rasp bars to the rear of the rotor.

By way of example, an axial threshing (and separating) system 20 is shown in FIG. 2, together with a cleaning apparatus 40.

The threshing system 20 comprises an axial rotor 22 beneath which is mounted the concave 24. The concave may have different sections along its length. The separating function involves conveying the crop stream rearwardly in a ribbon passing along a spiral path.

The initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 does not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 removes this unwanted material thus leaving a clean sample of grain to be delivered to the tank.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to this disclosure. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56 which removes tailings from the stream of grain before being conveyed to on-board tank (not shown) by grain collecting auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner.

This disclosure relates to the design of the feederhouse for delivering crop material to the threshing and separating systems. It may be used in a conventional (transverse) machine, an axial machine, or a hybrid machine (with transverse threshing and axial separation). In particular, this disclosure relates a dust ejection system for expelling dust from the feederhouse, in particular flowing in a back feeding direction.

The belt is preferably hydraulically driven, although it may be electrically driven. The belt is driven from one of the sprockets (front or back) of the belt, for example from the back of the belt where there is more space inside the combine harvester. A belt tensioning system is used to maintain belt tension, for example a spring-based tensioning unit. In a known manner, belt tensioning may be entirely manual, or the belt tension may be electronically monitored and then manually adjusted, or it may be electronically monitored and then automatically hydraulically or electrically adjusted (from the cab).

The belt is for example rubber, such as a rubber matting onto which lateral gripping bars (or recesses) are provided and optionally also longitudinal guiding bars (or recesses), or it may be formed using chains.

For example, there may be two narrow belt portions spaced apart with connecting gripping bars between them on the outer surface of the two belt portions (thereby forming an overall “belt”). Each belt portion is driven around a pair of sprockets. The inner surfaces of each belt portion have a row of teeth. Drive pins of the sprocket fit in the spaces between adjacent teeth. Alternatively, the belt may be formed by a pair of chains with connecting gripping bars, or it may be formed by a rubber belt across the full width of the feederhouse.

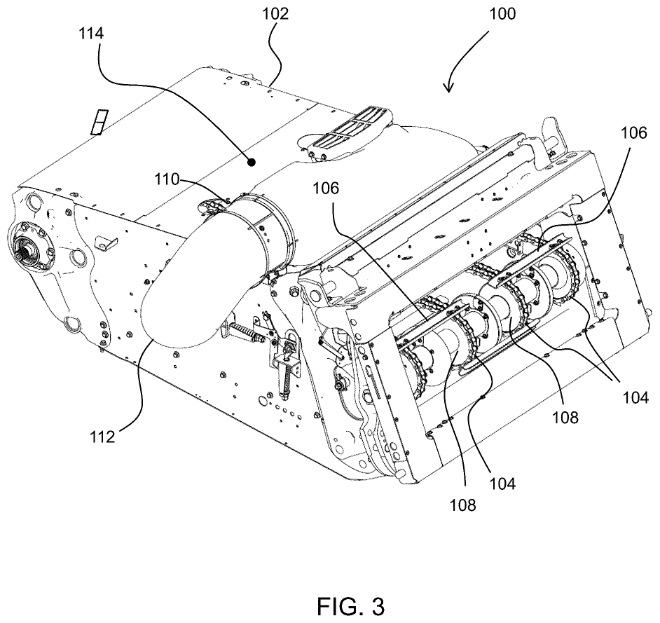

FIG. 3 shows a feederhouse 100 of a combine harvester. It has an outer housing 102 and a belt arrangement within the housing.

The belt arrangement has front and rear sprockets with a belt extending around the sprockets. FIG. 3 shows the end of the feederhouse that receives material from the header. In the example shown, there are two side-by-side belts. Each belt comprises a pair of chains 104 and interconnecting bars 106 between the chains. Each chain extends around a respective front sprocket 108, so that in this particular example there are four front sprockets and four rear sprockets (not shown).

In another arrangement, there may be a single belt formed as a rubber mat, or side by side rubber belts. This disclosure is not limited to any particular design of the belt arrangement.

A dust ejection system is provided, comprising a fan 110 for sucking dust from within the outer housing and an outlet 112 for delivering the sucked dust. The outlet directs the sucked dust in a desired direction, for example away from the front of the combine so that the visibility of the user is less impaired.

The outer housing 102 comprises an outer wall 114 having an opening which communicates with the outlet 112. The fan drives air flow from the opening to the end of the outlet 112.

The belt is driven to rotate such that, in a main material flow, it draws material away from the header and towards the processor. This may be considered to be the main material flow direction. In this example, the belt is driven main material flow direction at the underside, and it is driven in the opposite direction at the upper side. Thus, the belt arrangement is driven clockwise when viewing FIG. 3 from the left side.

Thus, the top of the outer housing is adjacent the belt portion at which the belt movement is opposite to the main material flow direction. Accordingly, the opening and the outlet communicate with the side of the belt where the belt movement is opposite to the main material flow direction.

In accordance with this disclosure, the opening that leads to the outlet 112 is provided with a convex guide surface. The convex guide surface promotes flow from within the outer housing to the outlet. In particular, it promotes the Coanda effect, by which a fluid jet has a tendency to stay attached to a convex surface, thereby entraining fluid from surrounding areas to create a region of lower pressure. This lower pressure assists in transferring material from within the outer housing to the outlet, and thereby enables efficiency improvements.

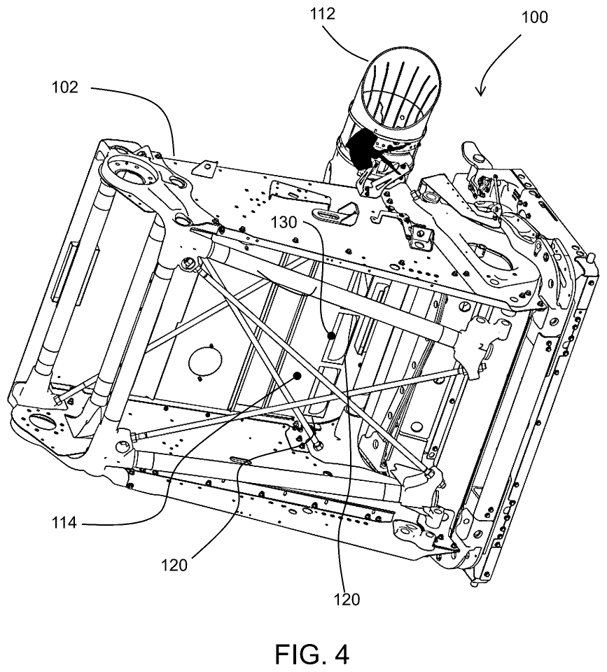

FIG. 4 shows the feederhouse of FIG. 3 from beneath with components removed to show the opening, in particular, a bottom cover of the outer housing, the belt and the sprockets are removed so that the underside of the top of the outer housing is visible.

The opening that leads (via the fan) to the outlet 112 can be seen. In this example, there is a line of openings 120 extending across the width of the outer housing (perpendicular to the material flow direction). Four openings 120 are provided in this example, but there could be fewer (including just a single long opening), or more.

The upstream end of each opening is connected to a convex guide surface 130 which extends in the downstream direction and curves towards the outlet. Thus, the flow of material is along the underside of the top of the outer housing, then around the convex guide surface and into an input end of the outlet. This is at an entrance side of the fan, whereas the distal end of the outlet is at the exit side of the fan.

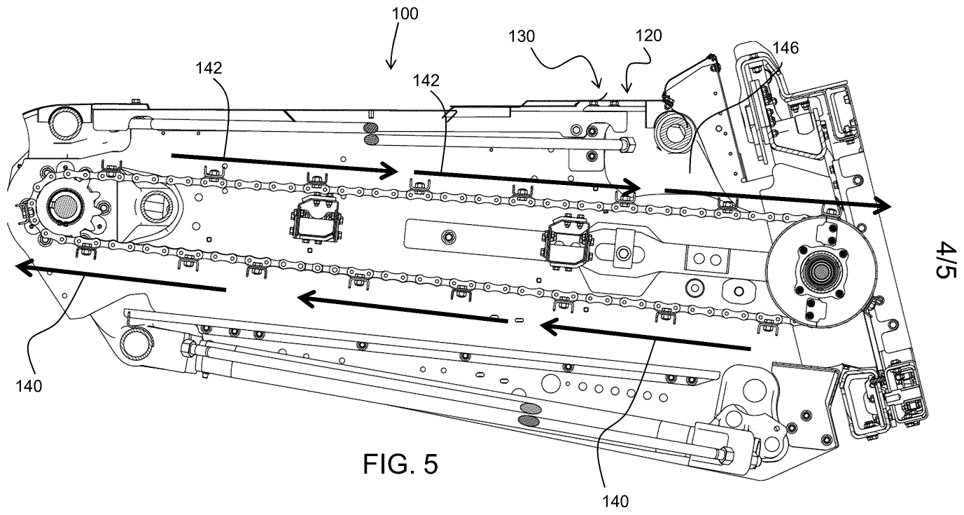

FIG. 5 shows the feederhouse of FIG. 3 in side view and is used to explain the flows within the feederhouse.

The main material flow is shown by arrows 140, beneath the belt arrangement. The back feeding flow is shown by arrows 142.

At the opening 120, incident material flows around the convex guide surface 130, promoting a less turbulent flow as well as creating an under-pressure which also make the suction process more efficient.

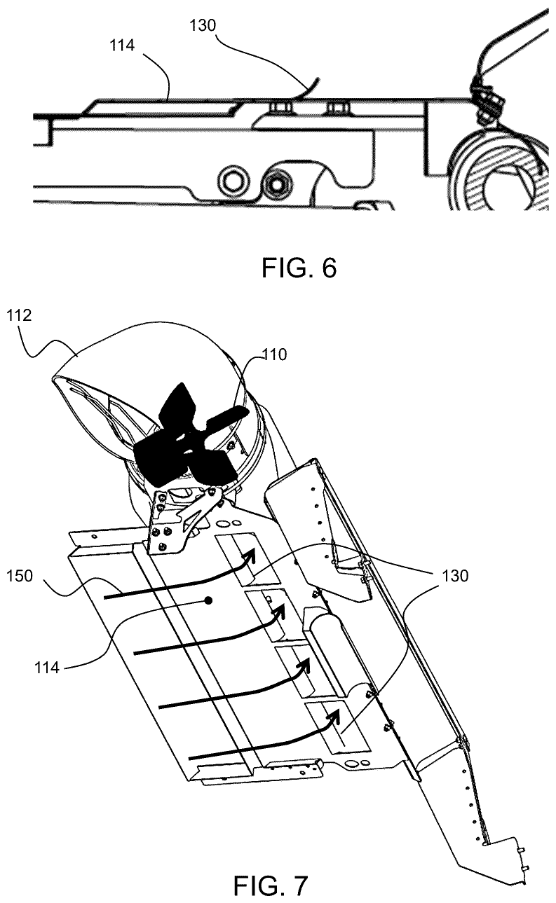

FIG. 6 shows the shape of the guide surface more clearly in side view.

The convex guide surface has a constant cross sectional shape in a plane parallel with the flow direction and perpendicular to the top of the outer housing (i.e. across the width of the feederhouse). It may have a constant radius of curvature (for example in the range 20 mm to 50 mm, such as 35 mm) or there may be a progressive change in the radius of curvature. The guide surface is smooth (i.e. no abrupt changes in gradient) to reduce turbulence.

By way of example, the guide surfaces may have a width (i.e. the dimension along the width direction of the combine) of 200 mm to 300 mm (e.g. 260 mm). The openings have a corresponding width and a length (i.e. the dimension along the fore-aft direction of the combine) of 50 mm to 150 mm (e.g. 100 mm).

The guide surface may be formed as a bent part integral to the main cover plate, but it can also be a separated part, welded or bolted on the cover plate. When formed as a bent part, some opening material is removed so that the ramp surface does not obstruct the material flow through the opening, but only helps the flow to go enter the opening.

FIG. 7 shows the guide surface 130 more clearly in perspective view. It shows the underside of the top of the outer housing from beneath. The guide surface curves upwardly, away from the interior volume of the outer housing. The flow is shown by arrows 150.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

What is claimed is:

1. A feederhouse of a combine harvester, comprising:
an outer housing;
front and rear sprockets inside the outer housing;
a belt inside the outer housing extending around the sprockets; and
a dust ejection system comprising a fan for sucking dust from within the outer housing and an outlet for delivering the sucked dust,
wherein the outer housing comprises an outer wall having an opening which communicates with the outlet, wherein the outer wall is at a side of the belt at which the belt movement direction is opposite to a main material flow direction,
and wherein an upstream end of the opening is connected to a convex guide surface wherein the curvature extends in the downstream direction and curves towards the outlet.

2. The feederhouse of claim 1, wherein the convex guide surface extends across a width of the opening, with a constant cross section along the width direction.

3. The feederhouse of claim 1, wherein the convex guide surface comprises the material, or a portion of the material, which has been removed from the outer wall to create the opening.

4. The feederhouse of claim 1, wherein a lower side of the belt has belt movement in the main material flow direction and an upper side of the belt has belt movement opposite to the main material flow direction.

5. The feederhouse of claim 4, wherein the outer housing comprises a top wall over the upper side of the belt, and the opening is provided in the top wall.

6. The feederhouse of claim 5, wherein the top wall comprises a line of openings extending across a width of the outer housing.

7. A combine harvester comprising:
a crop cutting head;
the feederhouse of claim 1;
a threshing system;
a separating system; and
a grain cleaning system for receiving the cut and threshed crop material.
